(19) United States
(12) Patent Application Publication
(10) Pub. No.: US 2013/0152021 A1
(43) Pub. Date: Jun. 13, 2013

(54) STAGE AND STAGE VIEW WITHIN A WORKFLOW

(71) Applicants: Tucker Hatfield, Redmond, WA (US); Bill C. Kennedy, Redmond, WA (US); Duhoi Heo, Seoul (KR); Hana Lee, Seoul (KR); Samuel Chung, (US); Min Kyo Lee, Seoul (KR); Seung Wook Son, (US); Soo Youn Cho, Seoul (KR); David Wadsworth, Redmond, WA (US)

(72) Inventors: Tucker Hatfield, Redmond, WA (US); Bill C. Kennedy, Redmond, WA (US); Duhoi Heo, Seoul (KR); Hana Lee, Seoul (KR); Samuel Chung, (US); Min Kyo Lee, Seoul (KR); Seung Wook Son, (US); Soo Youn Cho, Seoul (KR); David Wadsworth, Redmond, WA (US)

(73) Assignee: MICROSOFT CORPORATION, Redmond, WA (US)

(21) Appl. No.: 13/316,112

(22) Filed: Dec. 9, 2011

Related U.S. Application Data
(63) Continuation-in-part of application No. 13/316,108, filed on Dec. 9, 2011.

(51) Int. Cl. G06F 3/048

(52) U.S. Cl. 715/843; 715/810

(57) ABSTRACT

A method for providing workflow stages and integrated workflow stage visualization includes displaying a detailed view of a workflow, including a plurality of customizable stages, in the workflow user interface, wherein at least a first workflow stage of the plurality workflow stages is configured to contain a plurality of customizable workflow components, displaying the plurality of workflow components in the detailed view, receiving a selection of a stage view within the workflow user interface; displaying the stage view of the workflow, wherein the stage view includes the plurality of customizable stages but excludes the workflow components; and sending the workflow to the shared application platform.

### CROSS-REFERENCE TO RELATED APPLICATIONS

The present application is a continuation-in-part application of, and claims priority to, Application Attorney Docket No. 14917.1903US01/333726.01, U.S. patent application Ser. No. ______, entitled INTEGRATED WORKFLOW VISUALIZATION AND EDITING, filed Dec. 9, 2011, the entire content of which is hereby incorporated by reference.

### BACKGROUND

Workflows are computer-implemented representations of real world processes that exist within organizations. Workflows assist users with collaboration on documents and management of project tasks by implementing specific business processes on documents and items. Workflows also assist organizations with adherence to consistent business processes, and improve organizational efficiency and productivity by managing the tasks and steps involved in specific business processes.

### SUMMARY

A workflow support that creates one or more workflow component groups and an integrated visualization of the workflow component groups is provided. Workflow component groups may be stages representing at least one workflow component or action, and may further include one or more workflow activities. Workflow groups may be provided in a simplified visual view, enabling a user to visualize a high order logical flow of the workflow without having to view underlying programming logic.

An embodiment includes a system for providing workflow stages and integrated workflow stage visualization and editing. The system includes a workflow presentation tool operatively coupled to a shared application platform, the workflow presentation tool including a stage module capable of generating a workflow user interface configured to: display a detailed view of a workflow, including a plurality of customizable stages, in the workflow user interface, wherein at least a first workflow stage of the plurality workflow stages is configured to contain a plurality of customizable workflow components; display the plurality of workflow components in the detailed view; receive a selection of a stage view within the workflow user interface; display the stage view of the workflow, wherein the stage view includes the plurality of customizable stages but excludes the workflow components; and send the workflow to the shared application platform.

In another embodiment, a method for providing workflow stages and integrated workflow stage visualization and editing is disclosed. The method includes displaying a detailed view of a workflow, including a plurality of customizable stages, in the workflow user interface, wherein at least a first workflow stage of the plurality workflow stages is configured to contain a plurality of customizable workflow components; displaying the plurality of workflow components in the detailed view; receiving a selection of a stage view within the workflow user interface; displaying the stage view of the workflow, wherein the stage view includes the plurality of customizable stages but excludes the workflow components; and sending the workflow to the shared application platform.

A computer-readable medium including executable instructions that, when executed by a processor, provide workflow stages and integrated workflow stage visualization and editing is also disclosed. The computer-readable medium includes instructions executable by the processor for displaying a detailed view of a workflow, including a plurality of customizable stages, in the workflow user interface, wherein at least a first workflow stage of the plurality workflow stages is configured to contain a plurality of customizable workflow components; displaying the plurality of workflow components in the detailed view; receiving a selection of a stage view within the workflow user interface; displaying the stage view of the workflow, wherein the stage view includes the plurality of customizable stages but excludes the workflow components; and sending the workflow to the shared application platform.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

Referring now to the drawings in which like reference numbers represent corresponding parts throughout:

FIG. 1 shows system components for creating workflow stages;

FIG. 2 illustrates a user interface for stage creation according to one embodiment;

FIG. 3 shows a user interface for customizing one or more stages according to one embodiment;

FIG. 4 illustrates a stage transition according to one embodiment;

FIG. 5 illustrates an example of a flow sequence configured by a flowcharting tool according to one embodiment;

FIG. 6 illustrates an example of a visualization of a workflow within a workflow user interface including one or more stages according to one embodiment;

FIGS. 7A-7B illustrate stage containers and a corresponding visual representation of stage containers according to one embodiment;

FIG. 8 is a flowchart of a method for providing integrated workflow visualization and editing according to an embodiment; and

FIG. 9 is a simplified block diagram of a computing system in which embodiments of the present invention may be practiced.

### DETAILED DESCRIPTION

Embodiments of the present invention provide workflow support that creates one or more logical constructs within workflows and an integrated visualization of logical constructs within workflows. Specifically, embodiments provide a plurality of workflow component groups that make up at least a portion of a workflow and a simplified view of the plurality of workflow component groups. Workflow component groups may be stages representing one or more workflow actions, and visualization of such stages is provided.

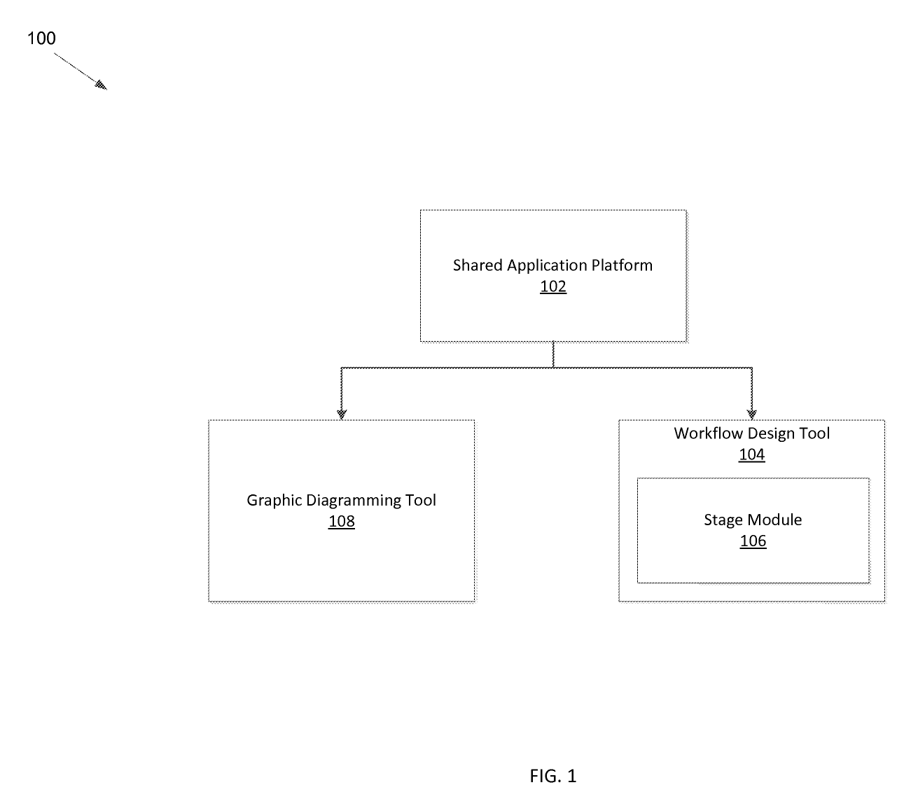

FIG. 1 illustrates the high level architecture of a system 100 for providing reusable workflows according to one embodiment. System may include a shared application platform 102 operably coupled to workflow design tool 104. Shared application platform 102 may be, for example, Microsoft® SharePoint® or a Microsoft® SharePoint® server. Workflow design tool 104 may be, for example, a version of a web application such as Microsoft® SharePoint® Designer. Workflow design tool 104 may also include a stage module 106 for customizing stages and transitions from one stage to another. Workflow design tool 104 may be a declarative workflow design application that enables a user to design a workflow using text based or natural language sentences that express business process tasks performed by actions. To this end, the workflow design tool 104 may be capable of generating visible user interface elements using a declarative markup language, such as Extensible Application Markup Language (XAML). The Extensible Application Markup Language is a declarative Extensible Markup Language-based language. A declarative markup language, such as XAML, enables a workflow where separate parties can work on the user interface and the logic of an application. Workflow design tool 104 may alternatively be a visual workflow design application. For instance, a visual workflow design application such as Microsoft Visual Studio® may be utilized to create workflows stages for shared services applications by creating visual groupings of workflow actions and visual connections between the workflow actions of one or more stages, for instance, either sequentially or via branches. In embodiments, the workflow design tool 104 may include both visual design and declarative design capabilities.

System 100 may also include graphic diagramming tool 108. Graphic diagramming tool 108 may be that may be resident on a client machine. For instance, a client machine may be the machine a business analyst or other non-technical user may utilize to view, edit, and otherwise interact with a workflow stage. In one embodiment, the workflow design tool 104 may create the initial workflow and save it to the shared services application 102. When the graphic diagramming tool 108 opens it, either a stage view or a detailed view may display. In the stage view, the order and connections between stages can be edited and saved back to the shared application platform 10. Any changes in the stage view may be automatically mapped to the detailed view. As used herein, the graphical diagramming tool 108 and the workflow design tool 104 are both workflow presentation tools. Embodiments are described with respect to workflow design tool 104, but may also be accomplished by graphical diagramming tool 108.

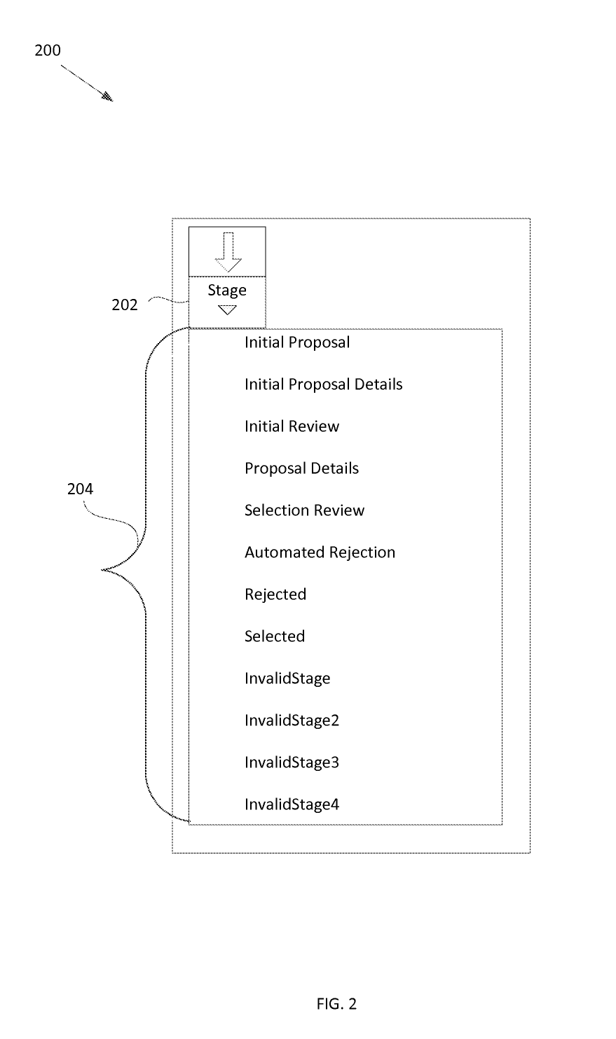

FIG. 2 illustrates a user interface 200 for creating on or more stages according to an embodiment of the disclosure. Stage module 106 of workflow design tool 104 may add one or more new containers to a workflow design. Stage module 106 is further configured to provide workflow component grouping into logical segments and provide a simplified visual view of the workflow component groupings. Workflow components may include any of workflow actions, items, tasks, steps, transitions or any other workflow aspects. Container may be labeled a “stage” container. Stage container may include container elements required for the workflow stage execution. Workflow stage data may be data required for controlling the workflow stage execution directly, or data that may be forwarded from one step execution to another. Each stage workflow container may contain one or more workflow stage components. A stage may hold any number of different workflow actions, actions, tasks, and/or transitions. For instance, a stage may be composed of one or more actions linked by common logic or theme. Stages may also include steps representing a grouped series of sequential actions. At each stage, data may be entered, modified, reviewed, or processed. Workflow stage container may also be capable of storing one or more workflow actions.

Workflow component groupings may also be presented to a workflow designer as visual representations of the one or more stages. A workflow designer may then directly modify a workflow at the stage level. The workflow designer can also add additional workflow logic within each stage such that the workflow will behave in the manner that an end user has outlined. Allowing workflow component grouping through stages allows a designer to group logically connected workflow components, and save the connected workflow components as, for example, a single file. Workflow stages may also be reusable. That is, a workflow designer may select one or more previously stored workflow stages and add the selected stage to a current workflow.

User interface components 200 may include a selectable stage tab 202. Stage tab 202 may be visible after a user has begun the process of creating a workflow with the workflow design tool 104. Workflow design tool 104 may receive a stage tab 202 selection through user interface 200. Stage tab 202 selection may result in the display of drop-down menu, pop-out dialog box, or any alternate means for providing one or more user selectable stages 204. For example, as shown in FIG. 2, workflow design tool 104 may then display a list of selectable workflow stages 204 in a drop-down menu. Selectable workflow stages 204 may include, for example, “Initial Proposal,” “Initial Review,” and “Selection Review.”

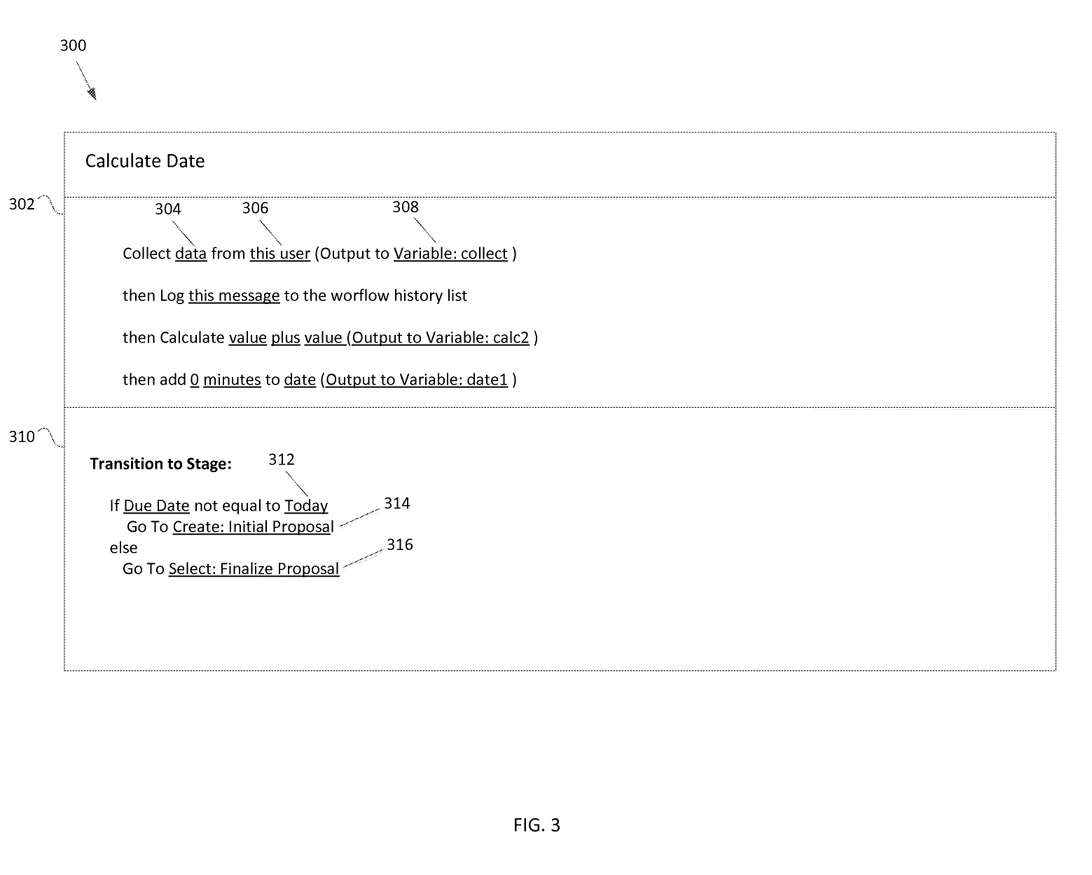

Workflow design tool 104 may receive a stage selection from a user. Upon receiving the selection of one or more of the stages 204, workflow design tool 104 may display a stage customization user interface 300. FIG. 3 illustrates a user interface 300 for editing stage parameters and providing stage transitions using a text-based workflow editor of the workflow design tool 104 according to one embodiment. Alternative stage design interfaces that provide a new stage creation starting point may be utilized. For instance, stages may be customized using visual based workflow logic. As shown in FIG. 3, user interface 300 may display one or more modifiable stage action components 304, 306, and 308 (e.g., the components for the “Collect data from this user” action). Stage action components 304, 306, and 308 may be selectable to select and customize stage action parameters or variables. Workflow design tool 102 may receive selections for one or more of the modifiable stage action components 304, 306, and 308 and utilize the selections to create the stage.

Selecting a workflow stage from the drop-down menu of stage user interface 202 may result in the display of a blank stage within which one or more command sentences 304 for editing the stage components of the workflow stage may be inserted. Once a user has selected a workflow stage, users may select one or more actions from an action user interface (e.g., an “Actions” drop down menu). As shown in FIG. 3, command sentences 302 may include, for example:

Collect data from this user (Output to Variable: collect )
then Log this message to the workflow history list
then Calculate value plus value (Output to Variable: calc2 )
then add 0 minutes to date (Output to Variable: date1 )

The above actions are discussed by way of example only. It is contemplated that any other actions may be added to a stage as desired by a workflow designer. Workflow command sentences 302 may include one or more selectable action components 304, 306, 308. As shown in FIG. 3a, where a user may be presented with a “Collect data from this user (Output to Variable: collect)” action sentence where the data 304, this user 306, and Variable:collect 308 stage components may be selected for further customization. One or more customizable portions of the workflow command sentences 304 presented to a user may include one or more data segments, one or more user segments and, one or more variables that may be selected for use in the workflow stage. To further customize each underlined portion, a user interface such as a dialog box or drop-down menu for customizing the selectable portion may display.

User interface 300 may also provide stage transition customization. A stage transition customization section 310 may be displayed and present a user with one or more customizable transition options. As shown in FIG. 3, stage transition section 310 (called, for example, “Transition to Stage”) may include:

If Due Date not equal to Today

Go To Create: Initial Proposal

else

Go To Select: Finalize Proposal

Stage transition section sentences may include one or more selectable action portions 312, 314, 316. As shown in FIG. 3a, a user may be presented with an “If” action sentence (e.g., “If Due Date not equal to Today” action sentence), where at least the Today 312 segment may be customizable. Transitions may be determined by the parameter selections of the “If” sentence. That is, a stage may be customized to flow to one or more other stages based on the result of the “If” sentence. For instance, as shown in FIG. 3a, the stage may transition to a “Create Initial Proposal” stage (e.g., by command “Go To Create: Initial Proposal” of FIG. 3a) if the “Due Date” variable does not equal today, or else may transition to a “Finalize Proposal” stage (e.g., by command “Go To Select: Finalize Proposal” of FIG. 3a). To further customize each underlined portion, a user interface such as a dialog box or drop-down menu for customizing the selectable portion may display. Other workflow stage components may also be customized from user interface 300.

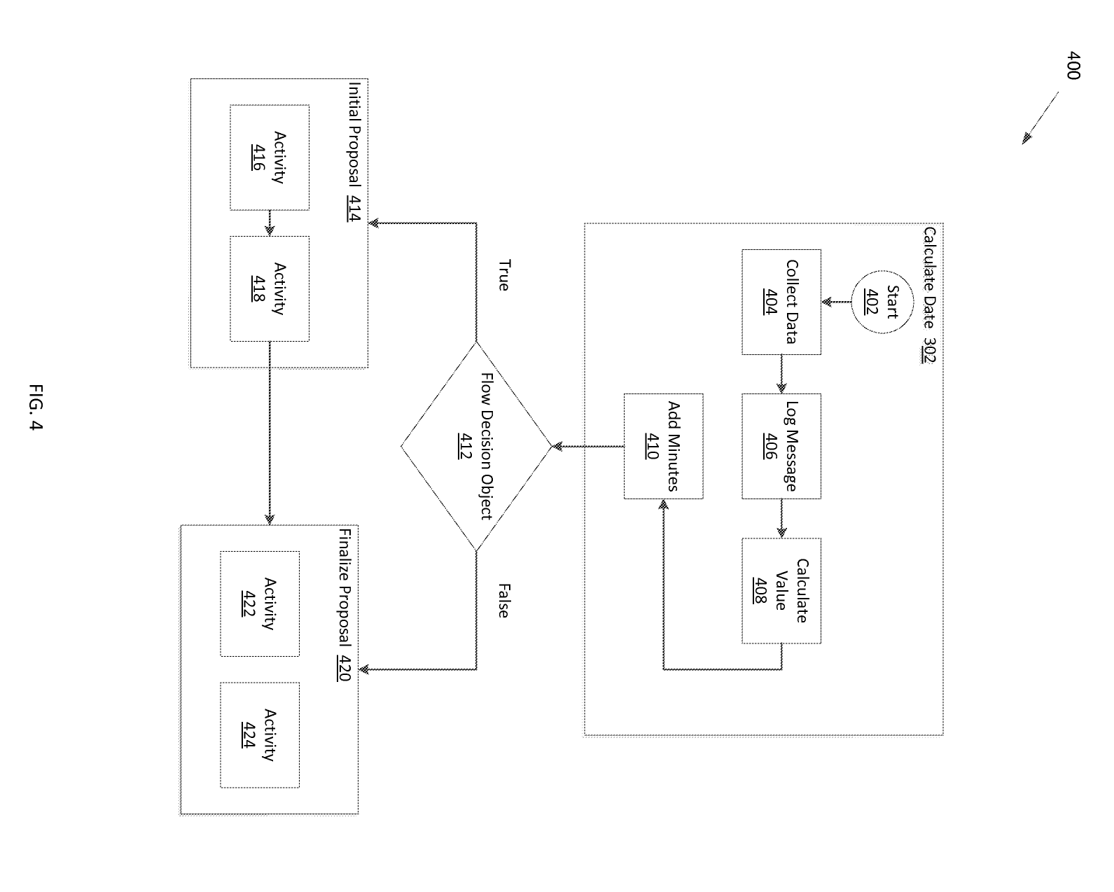

FIG. 4 illustrates a stage transition 400 according to on embodiment. Stage transition 400 further illustrates the sentence-based transition illustrated in FIG. 3. In FIG. 4, a first stage may be the “Calculate Date” 302 stage from FIG. 3. After a start 402 function, Calculate Date 302 stage may begin with a Collect Data 404 action for a particular user. After one or more parameters for the Collect Data 404 action have been determined, Calculate Date 302 stage may move to a Log Message 406 action, where a message regarding the outcome of the Collect Data 404 stage may be logged. Calculate Date 302 stage may then move to a Calculate Value 408 action for determining, for example, a date value. Calculate Date 302 stage may also include an Add Minutes 410 action, where a user may add time to the calculated date value. Upon setting all parameters and selecting all variables for the Calculate Date 302 stage, workflow may transition to a second stage via Flow Decision Object 412. Flow Decision Object 412 may include one or more “Go To” commands. For instance, the workflow may flow to an Initial Proposal 414 stage transition determination returns as true (e.g., if a date value is not equal to a previously determined date value (as shown in FIG. 3)), or to a Finalize Proposal 416 stage if the stage transition determination returns as false (e.g., the date value does equal the previously determined value). Initial Proposal 414 and Finalize Proposal 416 stages may further include one or more actions 416, 418, 422, 424. Additional stages, workflow actions, decision objects, transitions, or other workflow components may be included in the workflow.

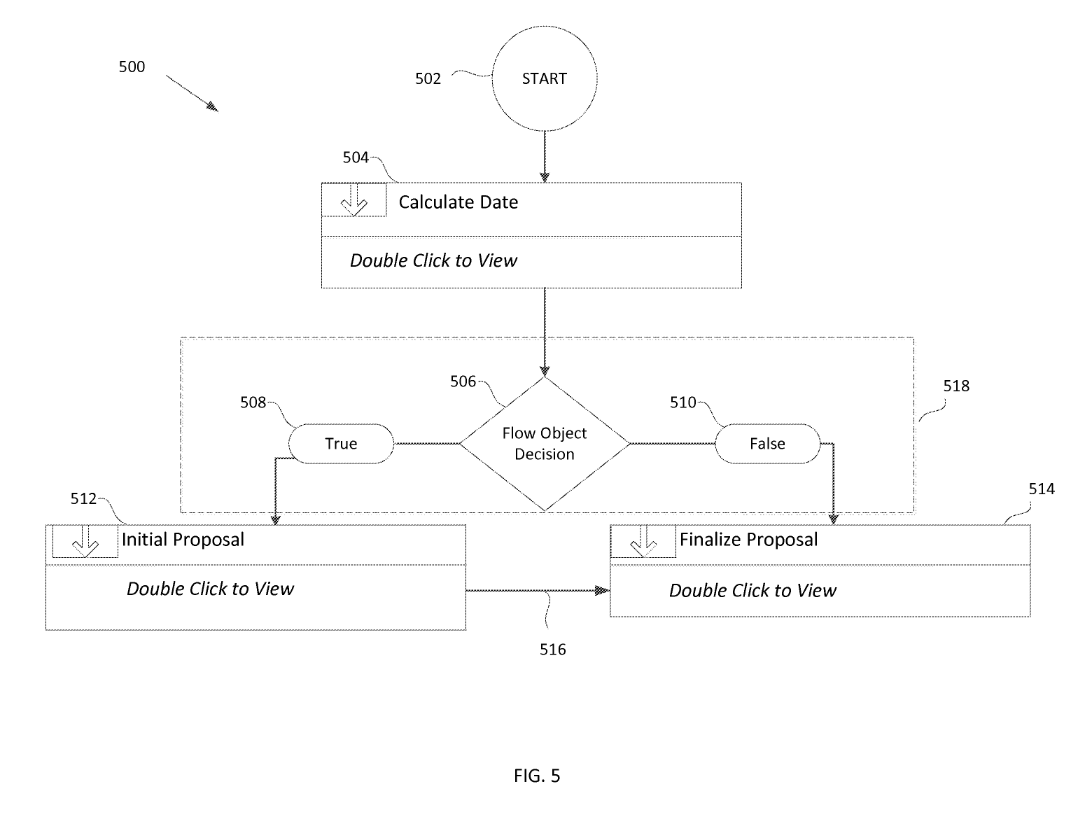

Flow sequences illustrated in FIG. 4 may be configured using any flowcharting tool. FIG. 5 illustrates an example 500 of a flow sequence configured by a flowcharting tool, wherein one workflow stage flows to other workflow stages via a decision object. Stages may be linked together with “Go-to” commands that allow the workflow to execute in a non-linear fashion (See FIG. 3). Each stage can then “Go-to” any other stage within the same workflow. A flowcharting tool may be included with the workflow design tool 104 or may be any external flowcharting tool operably coupled to the workflow design tool 104. In exemplary embodiments, a flowcharting tool is included in the workflow design tool 104. Each stage object of a workflow may be mapped to an activity sequence of the flowchart. Each activity sequence may be a container object containing all of the stage activities or actions within a stage.

As shown in FIG. 5, upon execution of a Start flownode 502, flowchart representing flow between stages begins. FIG. 5 illustrates the workflow of FIGS. 3 and 4 at a stage level. As shown in FIG. 5, a first stage 504 begins after Start flownode 502 is executed. A display name of the stage may be specified in the header (e.g., “Calculate Date”). The display name value may be edited in a “Properties” window of the flowcharting tool or directly on the activity designer header. From the first stage execution sequence 504 flow may proceed to another stage via decision node 506. Decision node 506 may include a condition and a flownode associated with each of two possible outcomes: True 508 or False 510. The condition may be evaluated and the value of this evaluation determines the next flownode to be processed within the flowcharting tool. For instance, if the condition is evaluated to be true 508, flowchart may proceed to a second stage 510 (“Initial Proposal”). If the condition is evaluated to be false 512, flowchart may proceed to a third stage 514 (e.g., “Finalize Proposal”). In addition, flow may proceed 516 to the third stage 514 following the second stage 512 even if the condition is evaluated to be true 510. In this instance, the transition from stage 512 to stage 514 is a simple “Go To” statement (a “flow next” object instead of a flow decision object) included as the transition from stage 512, whereas the transition from stage 504 to either of stage 512 or stage 514 is a flow decision object transition 518. The flowchart representation of FIG. 5 illustrates the workflow of FIG. 4 without the complexity of the underlying stage components included in each stage.

Workflow design tool 104 may be capable of generating stages based on the selected stage activity parameters and transitions. Generated stage selections may be integrated into a workflow as desired by a user. Workflow stages may be published to a shared services application such as shared application platform 102, stored on a server for accessing and reusing stage information in subsequently created stages and/or workflows.

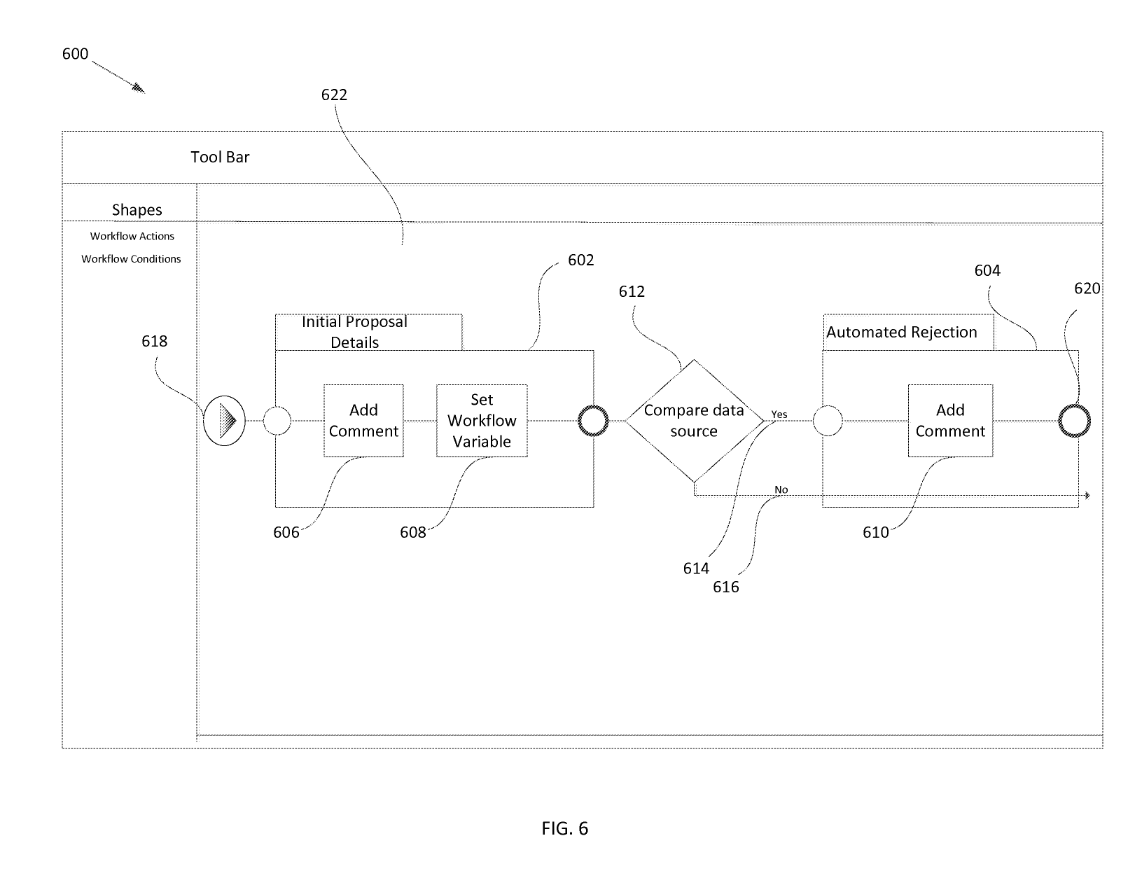

FIG. 6 illustrates an example of a visualization of a workflow within workflow user interface 600 including one or more stages according to one embodiment. Through further embodiments of the disclosure, a simplified visualization of one or more workflow stages is provided. As discussed hereinafter, workflow design tool 104 may create separate view which hides all of the workflow components within the stages. Workflow stages 602, 604 may include any number of stage components, such as actions 606, 608, 610, any number of decision objects (e.g., decision object 612) capable of providing one or more transitions 614, 616 to one or more additional stages, as well as start and end connectors 618, 620. Workflow stages 602, 604 may be created by customizing stage parameters transitions with user interface 300 as described in FIG. 3. The workflow design tool 104 may provide the shapes and intelligence used to build a workflow stage. Stages 602, 604 may be created by dragging stage shapes from a template or stencil (not shown) and dropping them onto a visual workspace 622. One or more actions may be dragged into a stage container. Decision shapes 612 may be dragged between stages to determine flow from stage to stage. Workflow design tool 104 may also provide validation for stages 602, 604, activities 606, 608, 610, decision objects 612, and transitions 614, 616. Validation may include the following: all action shapes are inside a stage, actions may only dragged into stages and may not exist outside of stages, and stage shapes do not overlap in the diagram to avoid issues with ownership of shapes in the stages, etc. The workflow 600 may be maintained using a declarative markup language file. The workflow visualization 600 may also be saved and published to the shared application platform 102, where it can be modified visually and by the setting of parameters using a workflow design tool 104. In addition, workflow design tool 104 may automatically translate a workflow created using the shape-based visual design user interface 600 into a sentence-based representation of the workflow as shown in FIG. 3. This allows personnel collaborating on the design of the workflow to work in the user interface most comfortable to that user.

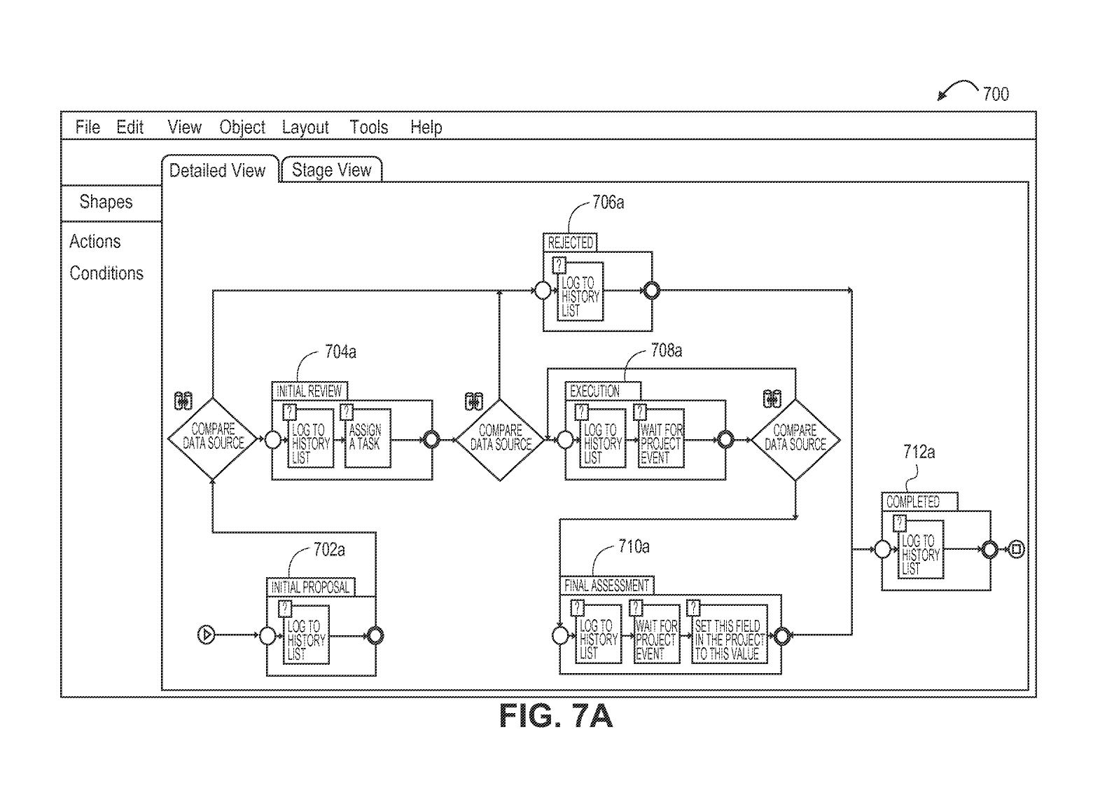

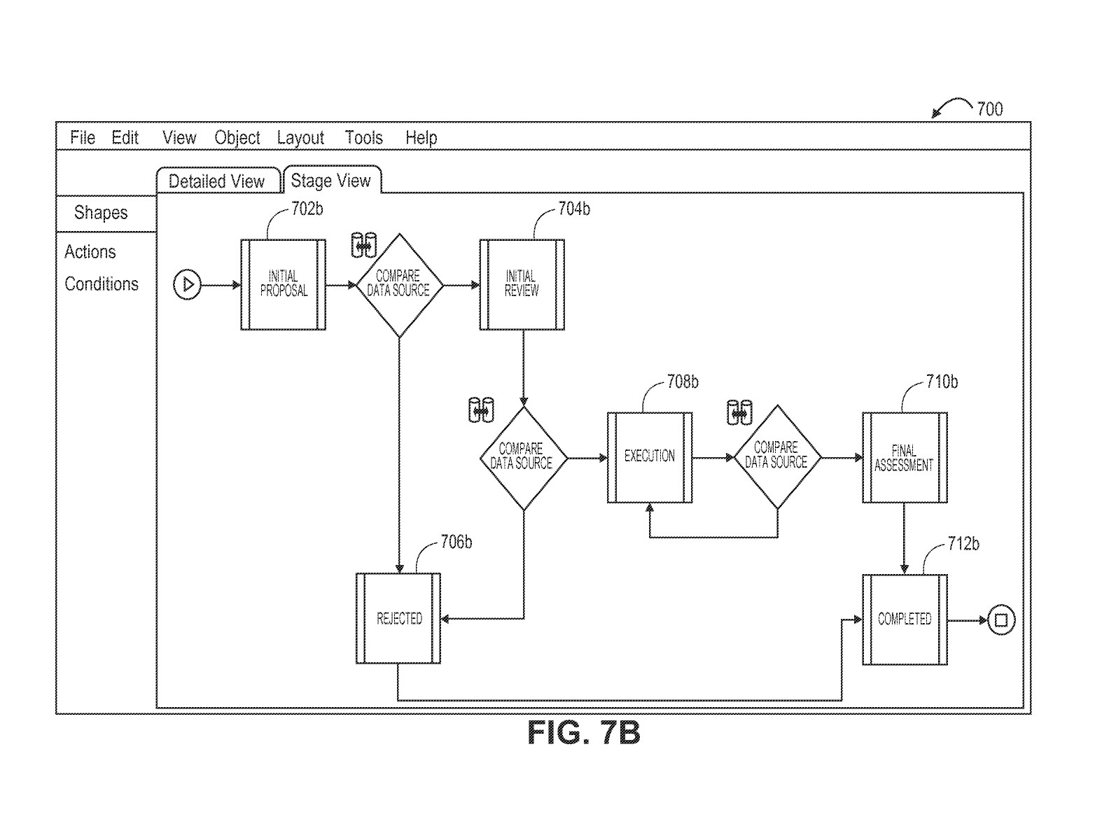

FIGS. 7A-7B illustrate a user interface 700 showing a detailed view and corresponding stage view of one or more workflow stages to one embodiment. In FIG. 7A, user interface 700 displays a Detailed View. In FIG. 7B, user interface 700 displays a Stage View. Workflow design tool 104 may enable toggling between the detailed view of FIG. 7A and the stage view of FIG. 7B. Specifically, user interface 700 may include one or more tabs for toggling between the two views (as can be seen in FIGS. 7A-7B, wherein one or the other of the Detailed View and Stage View tabs is selected). The detailed view and the stage view may be represented on different tabs within the same workflow document.

As shown in FIGS. 7A-7B, a detailed view of an Initial Proposal workflow stage 702a may be represented in the stage view of FIG. 7B by Initial Proposal visual stage element 702b. Likewise, a detailed view of an Initial Review stage 704a may be represented by Initial Review stage view element 704b. Similar stage view representations for respective detailed views of a Rejected stage 706a, an Execution stage 706a, a Final Assessment stage 710a, and a Completed stage 712a may be visually represented as Rejected visual stage element 706b, an Execution visual stage element 706b, a Final Assessment visual stage element 710b, and a Completed visual stage element 712b. As can be seen by FIGS. 7A-7B, the container name and any custom text from the stage may be preserved in the stage view. Stage shapes may be unique. For instance, a graphic diagramming tool 108 may not assign a stage shape to any other element of a workflow diagram. Also, an input can be received in the stage view to rearrange transitions between stages and order of stages that is then reflected in detailed view when the user toggles back. The original design, editing, and remapping of the changes may be accomplished solely by the workflow design tool 104, or may be accomplished by graphic diagramming tool 108. Workflow stage data may be stored on the shared application platform 102, the workflow design tool 104, or the graphic diagramming tool 108.

The stage view of FIG. 7B allows the user to create a visual model of the diagram which shows only stages as a visualization of a complex workflow. To enable “stage view” of one or more workflow stages, workflow design tool 104 or graphic diagramming tool 108 may provide a scaled-down visualization of stages and transitions. For instance, stage view of FIG. 7B may display a “simplified” diagram outlining the stages and a flow of the workflow between each stage. Stage view may be a view that a non-declarative editor user may utilize to understand the process flow and may further be enabled to directly modify the stage level logic directly from that view. An end user of a workflow portion, such as a business analyst tasked to review one or more aspects of a budget proposal, may be presented with the simplified visualization of one or more workflow stages.

In the stage view of user interface 700, users may create a diagram using stage view shapes, as well as use a stage view diagram to create a “real” workflow at the detailed stage level (as shown in FIG. 7A). Stage descriptions and the logic between the stages may then be outlined by the business analyst in either the workflow design tool 104 or the graphic diagramming tool 108 as desired without requiring the business analyst to have knowledge of workflow design tool language. The creation of a stage view in either the workflow design tool 104 or the graphic diagramming tool 108 enables the user to visualize a high order logical flow of workflow stages, and provides extendibility to the workflow diagram set. This may enable the user to easily visualize workflow stages as a flow diagram, and customize the flow diagram to include formatting as well as callouts, legends, or other content to make the flow more self-documenting. The resulting diagram can be used on its own merits as documentation for the process and can be easily sent to the application platform to complete the work necessary to automate the workflow.

All of the stage shapes in the new stage view may be hyper-linked to the original stage shapes within the original workflow diagram. This means that a user is able to scan the stage level diagram, and then click on any stage to drill into further details. A simplified visualization of workflow stages may be created by regenerating the workflow on a new page at the stage-level. Only the stages themselves and stage-level decisions, connectors, and start/end shapes may be drawn during this stage-view regeneration. The result is a series of new shapes representing stages and decisions that represent the overview of the workflow. Stage names and any custom text from the stage created by the workflow design tool 104 may be preserved in visualization. Users may create a diagram using stage view shapes, as well as use a stage view diagram to create a “real” workflow at the stage view level.

Stage and transition visualizations are capable of being transferred to and from graphic diagramming tool 108 via, for example, the shared services platform 102. For example, workflow design tool 104 may transfer workflow stage data to a graphic diagramming tool such as Microsoft® Visio. Transferred data may then be used to generate a simple shape-to-shape stage diagram. Higher level workflow details, such as code, design parameters, and underlying flow logic (e.g., how a workflow traverses from one task to another within a stage), may be concealed from an end user to allow a user with little or no design experience to view, process, or modify a workflow segment without concern for the effect of the user's action on other components of the workflow.

Changes to the order of stages or flow between stages made by a user at a stage level may be automatically synced to the detailed view of the workflow that includes stage components (e.g., FIG. 7A) and the sentence representation of a workflow (e.g., FIG. 3). To sync back and forth, the same code would traverse either of the two views and update the other view with the changes made. Stages and actions may be rearranged as desired by a user by dragging and dropping stage and action shapes from one location to another. Changes made to one view will display in the other view. In this manner, end users and declarative editors may collaborate directly to modify a workflow. An unsophisticated user may utilize stage view to make stage-level changes to the workflow, while a more adept workflow designer may work within the detailed view to make edits to components within stages. In embodiments, stages have multiple components, and the difference between the stage view and the detailed view may make the stage view considerably less intimidating for users with less experience in workflow design.

Further details of creating a stage view for workflow stages and editing such stages in both stage view, detailed view, and sentence-based interface, is provided in the aforementioned Application Attorney Docket No. 14917.1903US01/333726.01, U.S. patent application Ser. No. ______, entitled INTEGRATED WORKFLOW VISUALIZATION AND EDITING, filed Dec. 9, 2011, which has been incorporated by reference herein in its entirety.

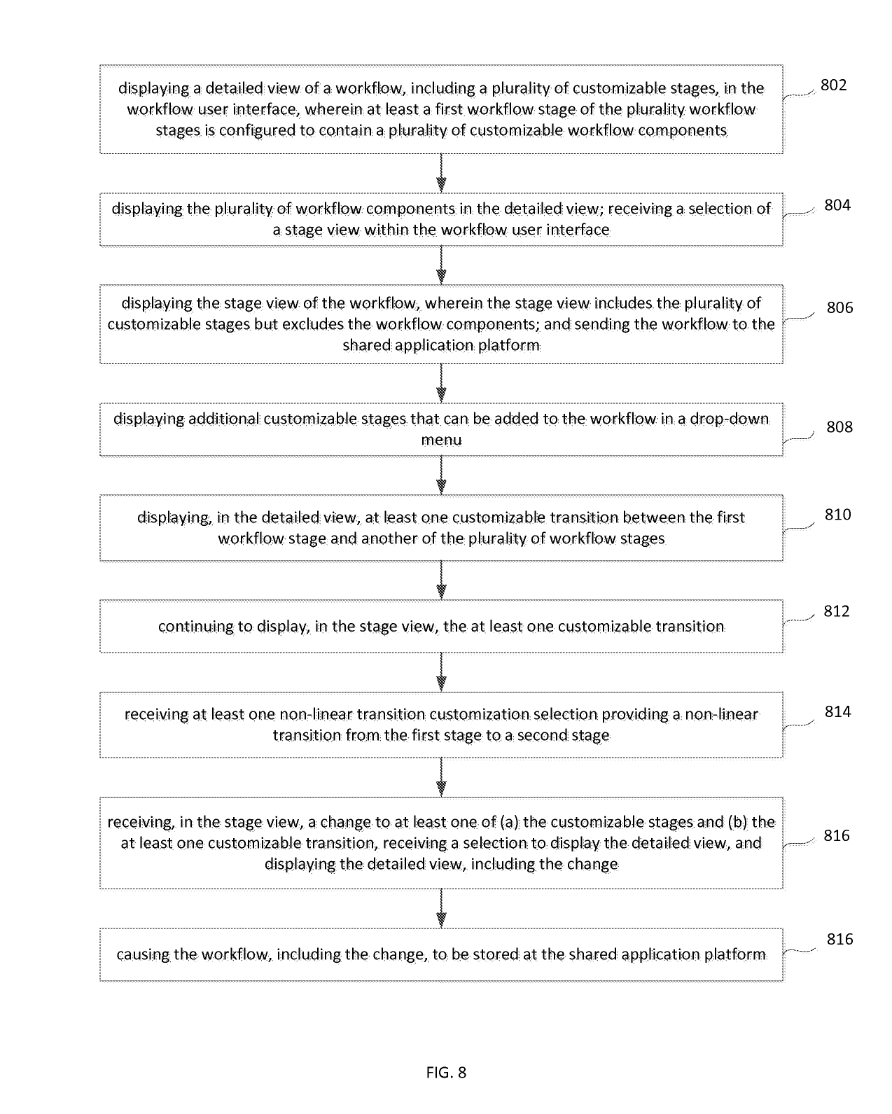

FIG. 8 illustrates a flow diagram of a method 800 for creating one or more workflow stages according to one embodiment. Method 800 includes displaying 802 a detailed view of a workflow, including a plurality of customizable stages, in the workflow user interface, wherein at least a first workflow stage of the plurality workflow stages is configured to contain a plurality of customizable workflow components. Method 800 includes displaying 804 the plurality of workflow components in the detailed view; receiving a selection of a stage view within the workflow user interface. Method 800 also includes displaying 806 the stage view of the workflow, wherein the stage view includes the plurality of customizable stages but excludes the workflow components; and sending the workflow to the shared application platform.

Method 800 further includes displaying 808 additional customizable stages that can be added to the workflow in a drop-down menu, and displaying 810, in the detailed view, at least one customizable transition between the first workflow stage and another of the plurality of workflow stages. Method 800 also includes continuing 812 to display, in the stage view, the at least one customizable transition. Method 800 may include receiving 814 at least one non-linear transition customization selection providing a non-linear transition from the first stage to a second stage. Method 800 may further include receiving 816, in the stage view, a change to at least one of (a) the customizable stages and (b) the at least one customizable transition, receiving a selection to display the detailed view, and displaying the detailed view, including the change. Method 800 may also include causing 818 the workflow, including the change, to be stored at the shared application platform.

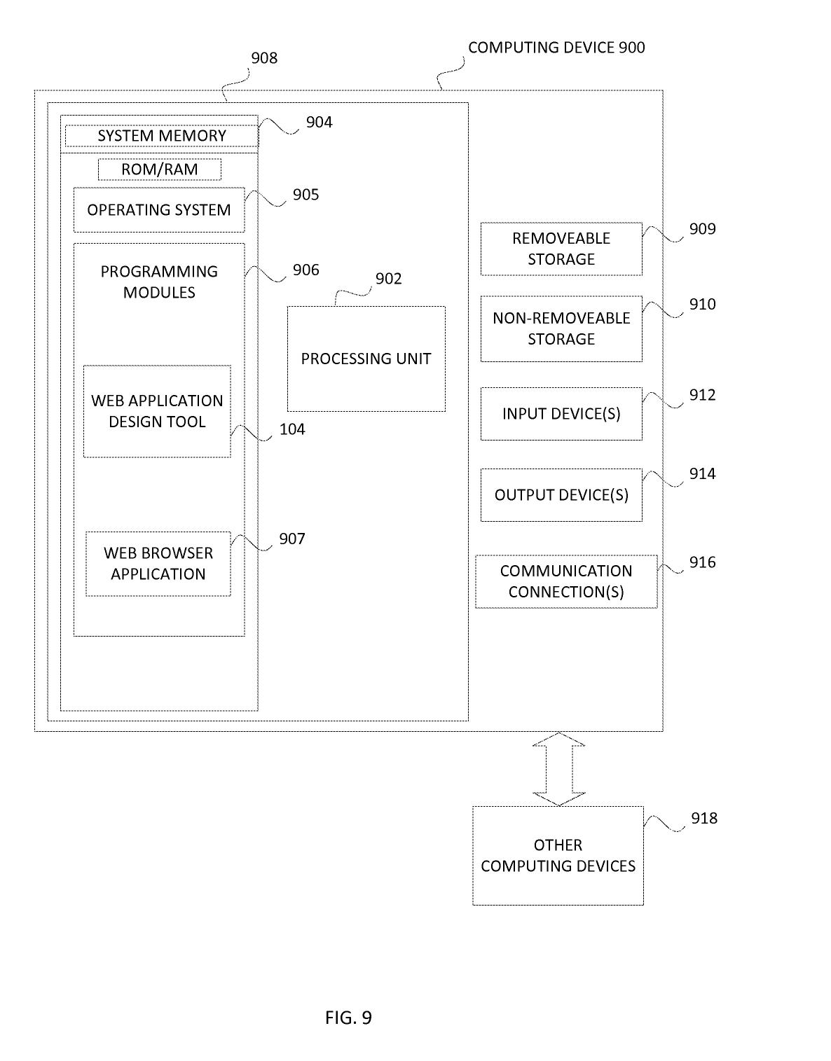

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 9 and its associated description provide a discussion of a variety of operating environments in which embodiments may be practiced. However, the devices and systems illustrated and discussed with respect to FIG. 9 are for purposes of example and illustration and are not limiting of a vast number of computing device configurations that may be utilized for practicing embodiments, described herein.

FIG. 9 is a block diagram illustrating example physical components of a computing device 900 with which embodiments may be practiced. In a basic configuration, computing device 900 may include at least one processing unit 902 and a system memory 904. Depending on the configuration and type of computing device, system memory 904 may comprise, but is not limited to, volatile (e.g. random access memory (RAM)), non-volatile (e.g. read-only memory (ROM)), flash memory, or any combination. System memory 904 may include operating system 905, one or more programming modules 906, and may include the workflow design tool 104 for providing project workflow creation and editing. Operating system 905, for example, may be suitable for controlling the operation of computing device 900. Furthermore, embodiments may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910.

As stated above, a number of program modules and data files may be stored in system memory 904, including operating system 905. While executing on processing unit 902, programming modules 906, such as the workflow design tool 104, may perform processes including, for example, one or more of the processes described above with reference to FIGS. 1-8. The aforementioned processes are an example, and processing unit 902 may perform other processes. Other programming modules that may be used in accordance with embodiments may include electronic mail and contacts applications, word processing applications, spreadsheet applications, database applications, slide presentation applications, drawing or computer-aided application programs, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip containing electronic elements or microprocessors. For example, embodiments may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the workflow design tool 104 may be operated via application-specific logic integrated with other components of the computing device/system 900 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, may be implemented as a computer process (method), a computing system, or as an article of manufacture, such as a computer program product or computer-readable storage medium. The computer program product may be a computer-readable storage medium readable by a computer system and encoding a computer program of instructions for executing a computer process.

The term computer-readable storage medium as used herein may include computer storage media. Computer storage media may include volatile and nonvolatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, etc. Output device(s) such as a display, speakers, a printer, etc. may also be included. The aforementioned devices are examples and others may be used.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments herein may be used in connection with mobile computing devices alone or in combination with any number of computer systems, such as in desktop environments, laptop or notebook computer systems, multiprocessor systems, micro-processor based or programmable consumer electronics, network PCs, mini computers, main frame computers and the like. Embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments.

Embodiments, for example, are described above with reference to block diagrams and/or operational illustrations of methods, systems, and computer program products according to embodiments. The functions/acts noted in the blocks may occur out of the order as shown in any flowchart or described herein with reference to FIGS. 1-8. For example, two processes shown or described in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable storage media, such as secondary storage devices, like hard disks, floppy disks, a CD-ROM, or other forms of RAM or ROM. Further, the disclosed processes may be modified in any manner, including by reordering and/or inserting or deleting a step or process, without departing from the embodiments.

It will be apparent to those skilled in the art that various modifications or variations may be made to embodiments without departing from the scope or spirit. Other embodiments are apparent to those skilled in the art from consideration of the specification and practice of the embodiments disclosed herein.

What is claimed:

1. A system for providing workflow stages and integrated workflow stage visualization comprising:
a workflow presentation tool operatively coupled to a shared application platform, the workflow presentation tool including a stage module capable of generating a workflow user interface configured to:
display a detailed view of a workflow, including a plurality of customizable stages, in the workflow user interface, wherein at least a first workflow stage of the plurality workflow stages is configured to contain a plurality of customizable workflow components;
display the plurality of workflow components in the detailed view;
receive a selection of a stage view within the workflow user interface;
display the stage view of the workflow, wherein the stage view includes the plurality of customizable stages but excludes the workflow components; and
send the workflow to the shared application platform.

2. The system of claim 1, wherein the workflow user interface displays additional customizable stages that can be added to the workflow in a drop-down menu.

3. The system of claim 1, wherein the workflow user interface displays, in the detailed view, at least one customizable transition between the first workflow stage and another of the plurality of workflow stages.

4. The system of claim 3, wherein the workflow user interface continues to display, in the stage view, the at least one customizable transition.

5. The system of claim 1, wherein the workflow user interface receives at least one non-linear transition customization selection providing a non-linear transition from the first stage to a second stage.

6. The system of claim 3, wherein the workflow user interface is further configured to:
receive, in the stage view, a change to at least one of (a) the customizable stages and (b) the at least one customizable transition;
receive a selection to display the detailed view;
display the detailed view, including the change.

7. The system of claim 6, wherein the workflow presentation tool is further configured to cause the workflow, including the change, to be stored at the shared application platform.

8. A method for providing workflow stages and integrated workflow stage visualization comprising:
displaying a detailed view of a workflow, including a plurality of customizable stages, in the workflow user interface, wherein at least a first workflow stage of the plurality workflow stages is configured to contain a plurality of customizable workflow components;
displaying the plurality of workflow components in the detailed view;
receiving a selection of a stage view within the workflow user interface;
displaying the stage view of the workflow, wherein the stage view includes the plurality of customizable stages but excludes the workflow components; and
sending the workflow to the shared application platform.

9. The method of claim 8, further including displaying additional customizable stages that can be added to the workflow in a drop-down menu.

10. The method of claim 8, further including displaying, in the detailed view, at least one customizable transition between the first workflow stage and another of the plurality of workflow stages.

11. The method of claim 10, further including continuing to display, in the stage view, the at least one customizable transition.

12. The method of claim 8, further including receiving at least one non-linear transition customization selection providing a non-linear transition from the first stage to a second stage.

13. The method of claim 10, further including:
receiving, in the stage view, a change to at least one of (a) the customizable stages and (b) the at least one customizable transition;
receiving a selection to display the detailed view;
displaying the detailed view, including the change.

14. The method of claim 13, further including causing the workflow, including the change, to be stored at the shared application platform.

15. A computer-readable storage medium comprising executable instructions that, when executed by a processor, provide stage creation and visualization, by:
displaying a detailed view of a workflow, including a plurality of customizable stages, in the workflow user interface, wherein at least a first workflow stage of the plurality workflow stages is configured to contain a plurality of customizable workflow components;
displaying the plurality of workflow components in the detailed view, further including further including displaying at least one customizable transition between the first workflow stage and another of the plurality of workflow stages;
receiving a selection of a stage view within the workflow user interface;
displaying the stage view of the workflow, wherein the stage view includes the plurality of customizable stages but excludes the workflow components; and
sending the workflow to the shared application platform.

16. The computer-readable storage medium of claim 15, further including displaying additional customizable stages that can be added to the workflow in a drop-down menu.

17. The computer-readable storage medium of claim 15, further including continuing to display, in the stage view, the at least one customizable transition.

18. The computer-readable storage medium of claim 15, further including receiving at least one non-linear transition customization selection providing a non-linear transition from the first stage to a second stage.

19. The computer-readable storage medium of claim 15, further including:
receiving, in the stage view, a change to at least one of (a) the customizable stages and (b) the at least one customizable transition;
receiving a selection to display the detailed view;
displaying the detailed view, including the change.

20. The computer-readable storage medium of claim 19, further including causing the workflow, including the change, to be stored at the shared application platform.
